(19) United States
(12) Patent Application Publication
(10) Pub. No.: US 2025/0112828 A1
(43) Pub. Date: Apr. 3, 2025

(54) NETWORK MANAGEMENT USING CENTRAL COMPUTER SYSTEM-LOCATED SERVERS AND LOCAL BRANCH NETWORK-LOCATED SERVER AGENTS

(71) Applicant: HEWLETT PACKARD ENTERPRISE DEVELOPMENT LP, Spring, TX (US)

(72) Inventors: Swaminathan Vasudevan, Roseville, CA (US); FNU Joseph Jobin, Roseville, CA (US)

(21) Appl. No.: 18/476,638

(22) Filed: Sep. 28, 2023

(51) Int. Cl. H04L 41/0894; H04L 9/40; H04L 41/082

(52) U.S. Cl. CPC H04L 41/0894; H04L 41/082; H04L 63/083

(57) ABSTRACT

A process includes establishing, by a local activate server agent of a first local branch computer network, a first connection with an activate server of a central computer system. The activate server manages network device validation information corresponding to a plurality of local branch computer networks, including the first branch local computer network. The process includes communicating, by a local activate server agent, with the central activate server over the first connection to receive network device validation information for a given network device associated with an entity that is associated with the first local branch computer network. The process includes, responsive to a given network device connecting to the first branch local computer network, establishing a second connection between the given network device and the local activate server agent. The process includes validating, by the local activate server agent, the given network device based on network device validation information for the given network device. The validation includes the local activate server agent communicating with the given network device over the second connection.

### BACKGROUND

When a network device (e.g., a network switch) first connects to a network, an onboarding process validates the network device and configures the network device to communicate with the network. Zero touch provisioning (ZTP) is an automated onboarding process, which does not involve user assistance.

### BRIEF DESCRIPTION OF THE DRAWINGS

FIG. 1 is a block diagram of a computer network having a hybrid network management solution that includes cloud-based servers and local server agents according to an example implementation.

FIG. 2 is a sequence flow diagram illustrating communications associated with the startup of a local activate server agent of a hybrid network management solution according to an example implementation.

FIG. 3 is a sequence flow diagram illustrating communications associated with the startup of a local central server agent of a hybrid network management solution according to an example implementation.

FIG. 4 is a sequence flow diagram illustrating communications to onboard a network device using a local activate server agent and a local central server agent of a hybrid network management solution according to an example implementation.

FIG. 5 is a sequence flow diagram illustrating communications between a local central server agent and a central server of a hybrid network management solution to manage network devices according to an example implementation.

FIG. 6 is a sequence flow diagram illustrating communications between components of a hybrid network management solution related to upgrading firmware of a network device according to an example implementation.

FIG. 7 is a flow diagram depicting a process to validate a network device using a central activate server and a local activate server agent according to an example implementation.

FIG. 8 is a block diagram of a system that includes a local activate server agent to validate a network device using information obtained from a central activate server according to an example implementation.

FIG. 9 is an illustration of machine-readable instructions that correspond to a local activate server agent and that, when executed by a machine, cause the machine to use information obtained from a central activate server to validate a network device according to an example implementation.

### DETAILED DESCRIPTION

A business enterprise may use a particular network management solution to manage its network devices. In this context, “managing” a network device refers to regulating any operational aspect of the network device. In an example, managing a network device may include onboarding the network device. In another example, managing a network device may include configuring the network device. In another example, managing a network device may include monitoring network telemetry metrics associated with or provided by the network device. In another example, managing a network device may include upgrading firmware of the network device.

A local network management solution may be appropriate for a smaller scale computer network (e.g., a single local area network). As its name implies, all of the components of a local network management solution may reside in the local network that contains the managed network devices. For example, the software components of a local network management solution may be hosted on one or multiple nodes (e.g., bare metal servers) of a computer network that contains the managed network devices. A cloud-based network management solution may be better suited for a relatively larger computer network. For example, an enterprise may have multiple local branch networks that are connected to a wide area network (WAN) (e.g., the Internet). As its name implies, the software and hardware resources of a cloud-based network management solution may be located in the cloud, and as such, the resources may be remotely disposed with respect to the network devices that are being managed by the solution. As compared to a local network management solution, a cloud-based network management solution may be highly scalable, which allows the solution to be tailored to the number of network devices and specific network infrastructure. Moreover, a cloud-based network management solution provides the capability for an enterprise to manage network devices of multiple branch networks from a single dashboard.

In an example, a cloud-based network management solution may be packaged as a subscription-based Software-as-a-Service (SaaS), which is provided by two main cloud-based components: a remote activate server and a remote central server. The remote activate server holds licenses and subscriptions for the managed network devices, and the remote activate server validates network devices when the network devices are first connected to the network. The remote central server manages other operational aspects of the network devices, which may include the central server forwarding user-provided configuration data (e.g., configuration files) to network devices and providing version firmware images to network devices for firmware upgrades. The remote central server may also perform such management services as monitoring network telemetry data that is provided by the managed network devices; identifying network device failure and performance issues based on the network telemetry data; and overseeing remedial measures to address network device failure and/or performance issues.

A cloud-based network management solution may face certain challenges that are not encountered by a local network management solution. For example, for a cloud-based network management solution, each managed network device may have a web socket connection with the central server, resulting in potentially hundreds to thousands of web socket connections (depending on the number of managed network devices) between the network devices and the remote central server. Such numerous web socket connections may contribute significantly to the remote central server's overhead. In another example, the large volume of network telemetry data from the network devices may be continually processed for all managed network devices at scale in the cloud, which may deteriorate performance (e.g., introduce delays in the appropriate network telemetry data being displayed to users). Other challenges may result from the management abstraction that is introduced by the cloud-based network management solution. For example, the abstraction may obscure troubleshooting visibility for a system administrator. As a more specific example, for purposes of resolving a connectivity issue for a network device, the abstraction may obscure identifying whether the connectivity issue is due to a connection problem (e.g., the network device has the wrong IP address for the remote central server), a validation failure (e.g., the network device does not have the correct credentials or has not been registered with the subscription account) or another reason. Moreover, due to the abstraction, a system administrator may be unable to identify whether the connectivity issue corresponds to a problem that is associated with the remote activate server or a problem that is associated with the remote central server.

In accordance with example implementations that are described herein, a hybrid network management solution includes on-premise, or local, network management components and remote, central (e.g., cloud-based) network management components. The hybrid network management solution significantly reduces the number of network connections with the managed network devices, as compared to a central network management solution. The hybrid network management solution, due to local gather and caching of network telemetry data, reduces the volume of network telemetry data that is communicated to the remote central server and correspondingly improves performance (e.g., reduces overhead time) of the telemetry monitoring. Moreover, unlike a central network management solution, the hybrid network management solution provides local network visibility to enhance troubleshooting. Additionally, unlike a local network management solution, the hybrid network management solution has cloud-based resources that may be scaled appropriately to accommodate the number of managed network devices and/or corresponding network infrastructure, and a system administrator may use a single dashboard to manage a group of network devices that are distributed among multiple local branch networks.

In accordance with example implementations, remote, central components of a hybrid network management solution include a remote activate server (e.g., a cloud-based activate server) and a remote central server (e.g., cloud-based central server). The managed network devices may be contained in one or multiple local branch networks. Each local branch network, in accordance with example implementations, includes local agents that correspond to and communicate with remote central components. More specifically, in accordance with example implementations, each local branch network includes a local activate server agent that corresponds to and communicates with the remote activate server, and each branch network includes a local central server agent that corresponds to and communicates with the remote central server. For high availability (HA), each branch network may include multiple local activate server agents (that correspond to and communicate with the remote activate server) and multiple local central server agents (that correspond to and communicate with the remote central server) that are hosted by multiple local compute nodes.

The local agents, in accordance with example implementations, start up and establish secure connections with their respective remote, cloud-based counterparts before any network devices connect for the first time to the local branch network. As part of this startup, the local activate server agent retrieves subscription and license information for a set of potential network devices that may be connected to the local branch network. In an example, this set of potential network devices may include network devices whose identifiers have been registered with the corresponding subscription but are yet to be onboarded onto any of the branch networks that are associated with the subscription.

In accordance with example implementations, when a network device first connects to the local branch network, the network device receives connection details (e.g., an Internet Protocol (IP) address) for the local activate server agent from a local dynamic host control protocol (DHCP) server. Using these connection details, the network device reaches out to and requests a connection with the local activate server agent. The local activate server agent may then validate the network device. Upon successful validation, the local activate server agent provides, to the network device, connection details (e.g., an IP address and a digital certificate) for the local central server agent.

The local central server agent, in accordance with example implementations, among its other functions, serves as a message broker between the managed network devices and the remote central server. In accordance with some implementations, the local central server agent has a single secure connection with the central server. The managed network devices send management-affiliated messages (e.g., messages containing network telemetry content) to the local central server agent, and the local central server agent consolidates, or groups, the messages into a set of one or multiple messages that are sent by the local central server agent to the central server over the agent's single secure connection with the remote central server. Moreover, in accordance with example implementations, the local central server agent demultiplexes, or separates, consolidated management-affiliated messages (e.g., messages containing configuration files) that are received from the remote central server into messages that are routed to the respective managed network devices. Therefore, due to the message multiplexing and demultiplexing by the central server agent, the number of network connections between the local central agent and the remote central server is minimized and is independent of the number of managed network devices.

Among its other features, the local central server agent may maintain a local database that is synchronized with a central database that is managed by the remote central server. In an example, the local database may store such information as data that represents the managed network device inventory and data that represents the last known good configurations for the managed network devices. Additionally, in accordance with some implementations, the local central server agent may preemptively retrieve newer version firmware images for the managed network devices as the newer firmware images become available. The local central server agent may store the retrieved firmware images in a local firmware repository that is managed by the local central server agent. The preemptive downloading of the firmware images into a local repository accelerates future firmware upgrades for the managed network devices.

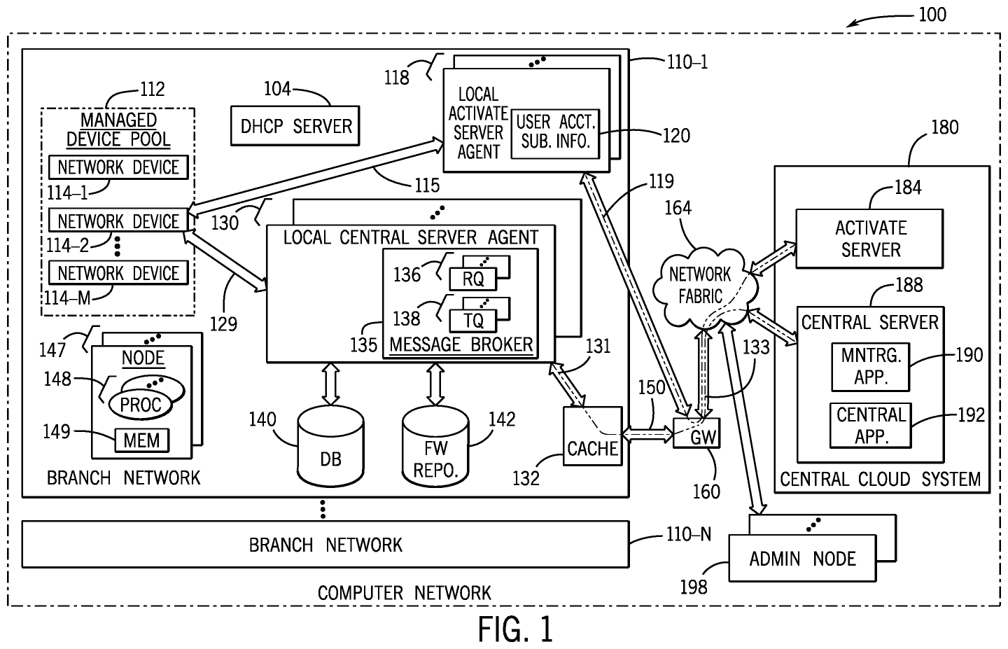

Referring to FIG. 1, as a more specific example, in accordance with some implementations, a hybrid network management solution that is implemented in a computer network 100 manages network devices 114 that may be contained in one or multiple local branch networks 110 (N branch networks 110-1 to 110-N being illustrated in FIG. 1 of the computer network 100). The hybrid network management solution includes remote central components of a central computer system and local components of the local branch networks 110. For the example implementations that is depicted in FIG. 1, the central computer system is a remote, cloud-based central cloud system 180 that include remote cloud-based components of the hybrid network management solution.

In the context used herein, “remote” and “local” are relative terms, designating whether entities or services are located in the same or different networks. In an example, a local network may be a private network. In an example, a remote network may be a private network in the cloud. In the context used herein, a “local branch” network is a network that is associated with a particular geographical location and communicates over network fabric with one or multiple other networks. A local branch network may alternatively be referred to as a “local branch computer network” or a “local network.” In an example, a local branch network may be a local area network (LAN). In examples, a local branch network may be a network that corresponds to a particular building, group of buildings or campus. In an example, a local branch network may correspond to an edge computer system. In another example, a local branch network may correspond to a system of Internet-of-Things (IoT) devices (e.g., sensors, controllers, cameras or other devices). In another example, a local branch network may correspond to an edge system.

In this context, a “central computer system” refers to a computer system that coordinates activities associated with multiple local branch computer networks. The central computer system may be remote, in that the components of the central computer system are not located in the same local branch network 110 as the managed network devices 114. In an example, a central computer system and the local branch networks may be part of a WAN. In an example, a central computer system may be a distributed system of hardware and software, which communicates with the local branch networks over WAN fabric. In an example, a central computer system may be a cloud-based system having software and hardware, which may be distributed over one or multiple computer racks, one or multiple data centers and one or multiple availability zones. In an example, a central computer system may provide a cloud-based service, such as a SaaS.

In this context, a “cloud-based” entity, such as a cloud-based server, refers to a unit of a distributed system of hardware and software, which is accessed over a WAN, such as the Internet. In an example, a cloud-based server may be virtual (e.g., may correspond to one or multiple virtual machines) and be hosted on one or multiple computer platforms (e.g., blade servers or rack servers). In examples, a cloud-based entity may be part of a public cloud, a private cloud or a hybrid cloud.

In the following implementations described herein, the central components of the hybrid network management solution are assumed to be remote, cloud-based components that are disposed in a remote central cloud system. It is noted that, however, in accordance with further implementations, the central components of a hybrid network management solution may be located in a remote central computer system (e.g., an enterprise's private computer system) other than a cloud-based computer system.

Although FIG. 1 depicts specific local components of the hybrid management solution for exemplary branch network 110-1, other branch networks 110 may have similar local components. The local branch networks 110 may have many different architectures or forms, depending on the particular implementation. Moreover, the local branch networks 110 may correspond to the same type of network or be associated with different types of networks (e.g., the branch networks 110 may include a mixture of campus, data center and IoT networks). In accordance with some implementations, a given local branch network 110 may be associated with a subscription to a network management service (provided by the hybrid network management solution) and associated with a particular subscription account holder. Moreover, in accordance with some implementations, multiple branch networks 110 may be associated with the same subscription and correspondingly, the same subscription account holder.

The cloud-based components of the hybrid network management solution include a remote activate server 184 and a remote central server 188. The remote activate server 184 manages data that represents subscriptions to the hybrid network management solution and network device license information. In an example, the subscriptions may be associated with respective user accounts, and each subscription may provide a license for up to a predetermined number of registered network devices 114. In an example, a user (e.g., a system administrator) may register specific network devices 114 (e.g., register via media access control (MAC) addresses or other network device identifiers) for a particular subscription.

In accordance with some implementations, the remote activate server 184 may generate data to drive a user interface through which a system administrator that is associated with a particular subscription account holder may view and update subscription and license information. In an example, the user interface may be a web-based graphical user interface (GUI) that may be accessed by the system administrator through an Internet browser that is hosted on an administrative node 198.

The remote central server 188 may perform a variety of management services for the managed network devices 114 in accordance with example implementations. In an example, the remote central server 188 may provide configuration data (e.g., configuration files) in connection with network device onboarding. In another example, the remote central server 188 may monitor network telemetry data. In another example, the remote central server 188 may identify potential or actual network device failure issues. In another example, the remote central server 188 may identify potential or actual network performance issues. In another example, the remote central server 188 may oversee remedial actions to correct network issues. In another example, the remote central server 188 may provide firmware images. For such purposes, the remote central server 188 hosts a monitoring application 190 and a central application 192.

The monitoring application 190, in accordance with example implementations, receives and processes network telemetry data (e.g., messages) provided by the network devices 114. In this context, “network telemetry data” generally refers to information or content, which represents information from which an insight to a state of a network, network device or client device connected network device(s) may be directly or indirectly determined. Network telemetry data may either be specifically requested (or “pulled”) from a network device 114 (e.g., provided in response to a request from the monitoring application 190) or provided (or “pushed”) by a network device 114 to the monitoring application 190 without being specifically requested.

In an example, network telemetry data may include a periodically measured statistic of a network or network device metric, or measurement. In an example, a statistic may be a traffic flow volume (e.g., a traffic flow volume for a particular VLAN) for a particular sampling period. In other examples, a statistic may be a periodically measured egress bandwidth, an ingress bandwidth, a latency, a round trip time, or a usage of a resource or an activity of a host. In other examples, network telemetry data may represent a value of a counter of a network device, a configuration setting of a network device, an event log of a network device, a state snapshot of a network device, a configuration snapshot of a network device, or other information about a network device. Network telemetry data may represent events. In an example, a network device may send network telemetry messages, which are triggered by certain change events (e.g., a network telemetry message triggered by the sending of a disassociation message by the network device). In In general, network telemetry data may represent information about the control, management and/or data planes of a network.

The processing of network telemetry data by the monitoring application 190 may take on a variety of different forms. In an example, the monitoring application 190 may generate, based on network telemetry data, data to graphically represent network telemetry metrics, network traces, statistics or other network-related information on a user interface. In another example, the monitoring application 190 may log network telemetry data and/or log network telemetry events. In another example, the monitoring application 190 may process network telemetry data to identify network issues. In an example, the monitoring application 190 may, based on network telemetry data, predict a failure or an underperformance of a network device 114, another network component (e.g., a server) or network subnet. In another example, the monitoring application 190 may, based on network telemetry data, identify an actual failure or underperformance of a network device 114, another network component or network subnet. In another example, the monitoring application 190 may identify a suboptimal configuration for a network device based on network telemetry data. In accordance with some implementations, the monitoring application's identification and/or prediction of network issues may be aided in whole or in part by one or multiple machine learning models. In an example, a particular machine learning model may be a supervised or unsupervised model. In accordance with some implementations, the monitoring application's identification of network issues may be aided in whole or in part through one or multiple knowledge databases, which associate issues with observed network telemetry metrics.

In accordance with some implementation, the monitoring application 190 may provide a recommended solution for an identified network issue. In an example, a recommendation be a suggested reconfiguration of one or multiple network devices 114. In another example, a recommendation may be a suggested reconfiguration of a particular network subnet. In another example, a recommendation may be a suggested replacement or upgrade of one or multiple network devices 114. In another example, a recommendation may be a suggested firmware upgrade for a particular network device 114 or group of network devices 114. In accordance with some implementations, the monitoring application's recommendations may be aided in whole or in part by one or multiple machine learning models (e.g., supervised or unsupervised models). In accordance with some implementations, the monitoring application's recommendations may be aided in whole or in part through one or multiple knowledge databases, which associate recommendations with specific network issues.

In accordance with some implementations, the monitoring application 190 may generate data to drive a user interface (e.g., a web-based GUI viewed through an Internet browser), such as a dashboard that is viewed on an administrative node 198. Through this dashboard, a system administrator, for example, may view network performance and network issues from all of the branch networks 110 that are associated with a particular user account.

The central application 192, in accordance with example implementations, may generate data to drive a user interface (e.g., a web-based GUI viewed through an Internet browser) through which a system administrator (via an administrative node 198) that is affiliated with a particular account holder may take actions to initiate various management-affiliated actions. In an example, an administrator may upload one or multiple configuration files to be installed on a particular network device as part of the onboarding of the network device 114. In another example, an administrator may initiate a reconfiguration of a network device 114. In another example, an administrator may approve a solution recommended by the monitoring application 190 to resolve a particular network issue. In another example, an administrator may initiate a firmware upgrade for a particular network device.

In accordance with example implementations, the hybrid network management solution includes local components that are located in the branch networks 110. As illustrated in FIG. 1, for the branch network 110-1, these local components include a local activate server agent 118 and a local central server agent 130. In accordance with example implementations, the local activate server agent 118 retrieves, via a single secure connection 119 with the remote activate server 184, user account subscription information 120 from the remote activate server 184. The user account subscription information 120 is relevant to licensed network devices 114 that are or may be onboarded to the branch network 110-1. As described further herein, the local activate server agent 118 is discovered by newly-connected network devices 114; validates the network devices 114 based on the user account subscription information 120 and possibly other criteria; and, for successfully validated network devices 114, provides, to the network devices 114, connection details for the local central server agent 130.

The local central server agent 130, among its other functions (described further herein), manages messaging between the network devices 114 and the central server 188 in a way that allows the use of a single, secure network connection (illustrated by dashed line 131 in FIG. 1) with the central server 188. The single network connection 131 advantageously reduces the overhead on the central server 188 (as opposed to, for example, a network connection for each network device 114).

In accordance with example implementations, the central cloud system 180 is connected to network fabric 164, and each local branch network 110 may be connected by a respective gateway 160 to the network fabric 164. The network fabric 164 may be associated with one or multiple types of communication networks, such as (as examples) Fibre Channel networks, Compute Express Link (CXL) fabric, dedicated management networks, local area networks (LANs), WANs, global networks (e.g., the Internet), wireless networks, or any combination thereof.

For the example implementation that is depicted in FIG. 1, the branch network 110-1 includes a pool 112 (or “managed network device pool 112”) of network devices 114 (M network devices 114-1 to 114-M being illustrated in FIG. 1) that have been onboarded to the branch network 110-1 and are managed by the hybrid network management solution. The network devices 114 may alternatively be referred to herein as “managed network devices,” as the network devices 114 are managed by the hybrid network management solution.

In the context that is used herein, a “network device” refers to an actual, or physical electronic component, which enables data communication between other components. In an example, a network device may be a switch that operates at level two (L2) of the Open Systems Interconnection (OSI) model to connect components of a computer network together. In another example, a network device may be a level three (L3) switch that connects both components of a computer network together and connects computer networks together. In other examples, a network device may be a gateway, a multicast router, a bridge, a component of a Gen-Z or a Compute Express Link (CXL) network, a processor device, a network interface controller (NIC) or a fabric switch that includes one or multiple of the foregoing devices. A network device may be a wired or wireless device.

The number of network devices 114 that are onboarded onto the branch network 110-1 may be less than the number of network devices that are registered for the particular subscription that covers the branch network 110-1. In an example, this discrepancy may be attributable at least in part to other network devices that are registered for the subscription being onboarded in one or multiple other branch networks 110. In another example, the discrepancy may be attributable at least in part to other network devices that are registered for the subscription but are not yet onboarded.

In accordance with example implementations, a network device 114, when connected to the branch network 110-1 for the first time, participates in an onboarding process. In this context, an “onboarding process” refers to a sequence of events that, if successful, configure the network device 114 to communicate with other devices of the branch network 110. Moreover, a result of a successful onboarding of the network device 114 may be that the network device 114 can communicate with devices outside of branch network 110.

In accordance with example implementations, the onboarding process may be a ZTP process (or “ZTP onboarding process” or “ZTP onboarding”). For the following examples, the ZTP onboarding for network device 114-2 are discussed, with it being understood that other network devices 114 may be onboarded in a similar manner. In an example, ZTP onboarding for the network device 114-2 may be initiated, or triggered, when the network device 114-2 is fully powered-up and is connected by a network cable to a component (e.g., a network switch, a top-of-the-rack (ToR) switch, a chassis controller or the gateway 160) that is associated with the branch network 110-1. In another example, the network device 114-2 may be a wireless device that is wirelessly connected to the branch network 110-1 to initiate onboarding of the network device 114-2.

In an example of ZTP onboarding, the network device 114-2 may be a DHCP client. When the network device 114-2 first connects to the branch network 110-1 and sends a DHCP discovery request, a DHCP server 104 of the branch network 110-1 responds to the DHCP discovery request with a message that contains an IP address for the network device 114-2 and one or multiple DHCP options. In accordance with example implementations, the DHCP server 104 may provide a DHCP option that identifies connection information for a local activate server agent 118. In an example, the connection information may be an IP address of the local activate server agent 118. In an example, the connection information may be a digital certificate that corresponds to the local activate server agent 118 and which may be used by the network device 114-2 for such purposes as providing a credential that allows the local activate server agent 118 to authenticate the network device 114-2.

The DHCP server 104 may provide one or multiple DHCP options other than connection information for the local activate server agent 118. In an example, a DHCP option may be an IP address of the gateway 160. In another example, a DHCP option may be an IP address of a domain name service (DNS) server. In another example, a DHCP option may be an IP address of a network time protocol (NTP) server. In another example, a DHCP option may be an identification of a minimum version firmware image for the network device 114-2, and another DHCP option may be an IP address of a Trivial File Transfer Protocol (TFTP) server from which the network device 114-2 may retrieve, if noncompliant, a firmware image that complies with the minimum firmware image. In another example, a DCHP option may identify a configuration file from which settings (e.g., NTP settings, SNMP settings, DNS settings, sflow settings or other settings) for the network device may be retrieved and an IP address of a server that provides the configuration file may be found.

The network device 114-2 uses the connection information provided by the DHCP server 104 to provide a connection request to the local activate server agent 118. As part of the ZTP onboarding process, in accordance with example implementations, the network device 114-2 provides a connection request to the local activate server agent 118. In response to the connection request, the local activate server agent 118 validates the network device 114-2. This validation may involve the local activate server agent 118 considering any of a number of different criteria. In an example, a criterion may be whether the network device 114-2 possesses a pre-shared key that corresponds to a pre-shared key that is possessed by the local activate server agent 118. In an example, a criterion may be whether the network device 114-2 has a particular digital certificate. In an example, a criterion may be whether an identifier (e.g., a MAC address) of the network device 114-2 is on list of MAC address associated with a subscription that corresponds to the local network branch 110. In this manner, the local activate server agent 118 may check an identifier (e.g., a MAC address) of the network device 114-2 against the user account subscription information 120. In an example, a criterion may be whether a device type of the network device 114 is compatible with an architecture or configuration of the local branch network 110. In an example, a criterion may be whether a version or model of the network device 114-2 is compatible with a configuration or an architecture of the local branch network 110 (e.g., a consideration of whether the network device 114-2 corresponds to a minimum version that supports certain features).

Responsive to the local activate server agent 118 successfully validating the network device 114-2, a connection 115 may then be formed between the local activate server agent 118 and the network device 114-2. Using the connection 115, the local activate server agent 118 may then send, to the network device 114-2, data representing connection details for the local central server agent 130. In an example, the connection details may include an IP address of the local server agent and a digital certificate.

Responsive to receiving the connection details for the local central server agent 130, the network device 114-2 may then send a connection request to the local central server agent 130. Upon the local central server agent's successful validation of the network device 114-2, a secure connection 129 may then be formed between the local central server agent 130 and the network device 114-2.

In accordance with some implementations, the local central server agent 130 includes a message broker 135 that provides a streamlined message queue service for handling message traffic that is communicated between the network devices 114 and the remote central server 188. In this context, a “message broker” generally refers to an entity that allows different entities (e.g., instances, services and systems) to communicate with each other. In general, a message broker may perform message validation, format transformations and routing of messages among different entities. The message broker 135 may use any of a number of different message protocol standards, such as Kafka, message queuing telemetry transport (MQTT), Apache, RabbitMQ, or other message protocol standard.

As depicted in FIG. 1, in accordance with some implementations, the message broker 135 may include multiple transmit queues 138 and multiple receive queues 136. In an example, the receive queues 136 may be associated with respective network devices 114 and may temporarily store transient data representing messages that are received from the remote central server 188. In an example, the transmit queues 138 may be associated with respective network devices 114 and may temporarily store transient data representing messages that are sent by the respective network devices 114 to the remote central server 188.

In accordance with example implementations, the local central server agent 130 accumulates, in the transmit queues 138, messages that are sent by the network devices 114 to the central server 188. When triggered, the local central server agent 130 consolidates the messages from all of the transmit queues 138 (to therefore empty the transmit queues 138) and sends, via a secure connection (represented by dashed line path 131 in FIG. 1) with the central server 188, one or multiple messages containing the content of the messages sent by the network devices 114. In an example, triggers for consolidating and sending the data may be correspond to times of a predefined schedule. In another example, a trigger may be a full status or near full status (e.g., a certain percentage or queue full level) of any of the transmit queues 138. In another example, a trigger may be generated responsive to metrics indicating full statuses of the transmit queues. In another example, a trigger may be based on a maximum wait time for data being in a transmit queue 138. The message broker 135 may trigger the sending of messages to the central server 188 based on one or multiple other criteria, in accordance with further implementations.

In accordance with example implementations, the remote central server 188 sends messages for all of the network devices 114 of the branch network 110-1 over the single secure connection 131 with the local central server agent 130. The message broker 135 sorts received messages from the remote central server 188 by placing the messages into the appropriate receive queues 136 before forwarding the messages to the appropriate network devices 114.

As depicted in FIG. 1, in accordance with example implementations, a cache 132 may be located between the local central server agent 130 and the gateway device 160. The cache 132 promotes fast data retrieval and synchronization. In an example, the cache 132 may be an in-memory data store, such as a Redis in-memory data store or other data store.

In accordance with some implementations, the local central server agent 130 may maintain a local database 140 that mirrors a database (not shown) that is maintained by the remote central server 188. In an example, the local database 140 may store data that represents the last known good state for each of the network devices 114. In another example, the local database 140 may store data that represents the latest configuration state of each of the network devices 114. In another example, the local database 140 may store data that represents the most recent telemetry data provided by each of the network devices 114. In another example the local database 140 may store data represent a solution or a diagnosis for a network device 114 that was provided by the central application 192. The local central server agent 130 and the remote central server 188 may communicate messages over the secure connection 131 for purposes of communicating changes made to either side's database and ensure that the data stored in both databases is consistent.

As also depicted in FIG. 1, in accordance with example implementations, the local central server agent 130 may maintain and use a firmware repository 142. The firmware repository 142, in general, stores firmware images that may be used to upgrade the firmware of network devices 114.

In accordance with some implementations, the local central server agent 130 may preemptively download firmware images from the remote central server 188. In this context, the local central server agent 130 “preemptively downloading” a firmware image refers to the local central server agent 130 retrieving the firmware image from the remote central server 188 without first being requested to perform a corresponding firmware upgrade on a particular network device 114 using the firmware image.

In an example, the preemptive downloading of firmware images for a particular network device 114 or set of network devices 114 may be controlled by a particular policy. In an example, a policy may specify that the local central server agent 130 is to retrieve firmware images, when available, which correspond to newer versions of firmware than the firmware that is currently installed on the network devices 114 and store the retrieved firmware images in the firmware repository 142. In an example, a policy may allow a certain number of newer version firmware images to be retained in the firmware repository 142 so that when the firmware for a particular network device 114 is to be upgraded, multiple firmware upgrade options are available for selection (e.g., a selection made by a system administrator). In an example, a particular firmware image may correspond to multiple network devices 114. Preemptive downloading a firmware image accelerates its retrieval when the firmware of a network device 114 is to be upgraded; and in addition, the firmware validation and update may be smoother and quicker due to the local availability of the firmware image.

Among its other features, in accordance with some implementations, the local central server agent 130 may provide a troubleshooting remote user interface, which allows a system administrator to diagnose and manage any issues with the local components of the hybrid network management solution. In an example, the local central server agent 130 may provide a virtual private network (VPN) server connection that allows a VPN client (e.g., a VPN client of an administrative node 198) to access the branch network 110-1 for troubleshooting purposes. Moreover, in accordance with example implementations, the local activate server agent 118 may provide a troubleshooting remote user interface (e.g., a VPN server interface), for purposes of allowing a system administrator to troubleshoot issues associated with the local activate server agent 118.

In accordance with some implementations, the activate server 184 and the central server 188 may correspond to machine-readable instructions (or “software”) that are executed on one or multiple nodes of the central cloud system 180. In the context that is used herein, a “node” refers to a processor-based entity that has an associated set of hardware and software resources. In an example, a “node” may be a computer platform. In this context, a “computer platform” is a processor-based electronic device, which has an associated operating system. As examples, a computer platform may be a rack server or blade server. In another example, a “node” may be virtualized. For example, a node, in accordance with some implementations, may include an abstraction of hardware and software resources of a physical computer platform, such as a virtual machine.

In accordance with some implementations, the remote central cloud system 180 may include multiple remote activate servers 184 and multiple remote central servers 188. In an example, different pairs of an remote activate server 184 and a remote central server 188 may form respective network management clusters. In this manner, in accordance with some implementations, a network management cluster for a set of branch networks 110 may include an remote activate server 184; a remote central server 188; local central server agents 130 that are located in the set of branch networks 110; local active server agents 118 that are located in the set of branch networks 110; and the network devices 114 that are located in the set of branch networks 110.

In accordance with example implementations, for purposes of providing high availability (HA), multiple local central server agents 130 and multiple local activate server agents 118 may be located in the same branch network 110. As depicted in FIG. 1, the branch network 110-1 includes multiple local central server agents 130. In an example, local central server agent tasks may be distributed among multiple local central server agents 130 of an HA group. In an example, each local central server agent may be assigned to a particular group of the network devices 114 and handle central server agent tasks for the network devices 114 of the assigned group. Continuing the example, should a particular local central server agent 130 of the HA group fail, the responsibilities of the failed local central server agent 130 may fail over to the remaining active local server agents 130 of the HA group. In a similar manner, in accordance with some implementations, for purposes of providing HA, the branch network 110-1 may include multiple local server agents 118 that form an HA group. In an example, activate server agent tasks may be distributed among the local active server agents 118 of the HA group. In an example, each local activate server agent 118 may be assigned to a particular group of the network devices 114 and handle validation of network devices 114 of the assigned group. Continuing the example, should a particular local activate server agent 118 of the HA group fail, the responsibilities of the failed local activate server agent 118 may fail over to the remaining active local activate server agents 118 of the HA group.

In accordance with example implementations, the local components of the hybrid network management solution may be hosted by nodes of the branch network 110. As depicted in FIG. 1, for the branch network 110-1, a given local central server agent 130 may be associated with a set of machine-readable instructions (or “software”) that execute on one or multiple nodes 147 of the branch network 110-1. Moreover, in accordance with example implementations, a given local activate server agent 118 may include a set of machine-readable instructions that execute on one or multiple nodes 147 of the branch network 110-1.

A given node 147 may be physical or virtual. Regardless of its particular form, the node 147 may be associated with one or multiple hardware processors 148 and a memory 149. The hardware processor 148 is a physical, or actual, processor that executes machine-readable instructions (e.g., software or firmware instructions). In examples, the processor 148 may include one or multiple central processing unit (CPU) cores, or one or multiple graphics processing unit (GPU) cores. The memory 149 is a non-transitory storage media that may be formed from semiconductor storage devices, memristor-based storage devices, magnetic storage devices, phase change memory devices, a combination of devices of one or more of these storage technologies, and so forth. The memory 149 may represent a collection of memories of both volatile memory devices and non-volatile memory devices. In accordance with some implementations, one or multiple nodes 147 may be hosted on a particular physical computer platform, such as a bare metal server, a server blade, a rack server, or another computer platform of the branch network 110-1.

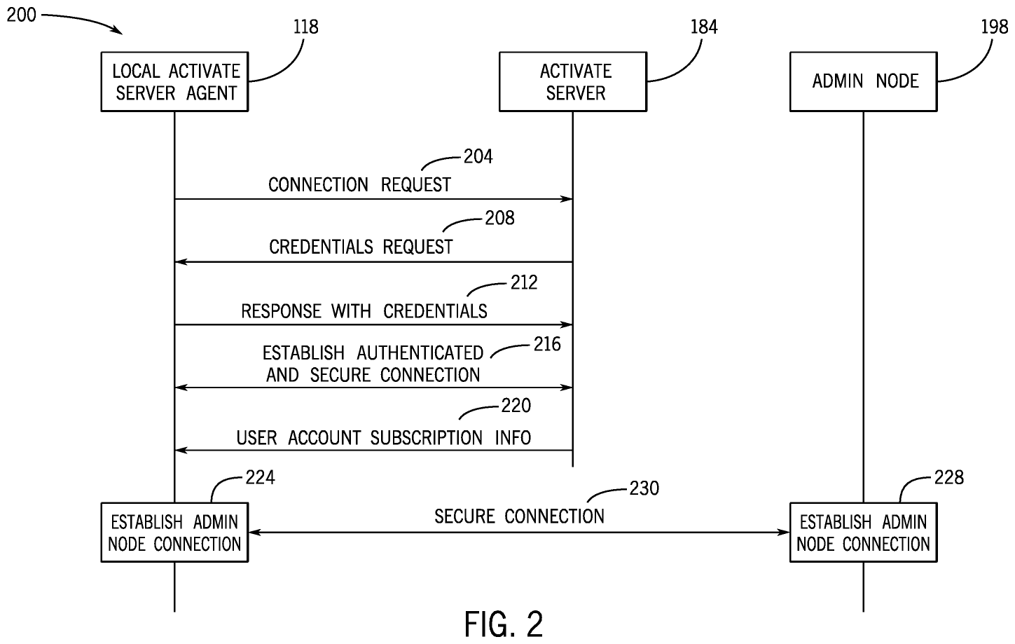

In accordance with example implementations, prior to any network devices 114 being connected or onboarded to the branch network 110-1, the local components of the hybrid network management solution are first installed and started. In accordance with example implementations, the first local component that is started is the local activate server agent 118. FIG. 2 depicts a sequence flow diagram 200 illustrating communications associated with the startup of a local activate server agent in accordance with example implementations.

Referring to FIG. 2, responsive to the local activate server agent 118 starting up, the local activate server agent 118 sends a connection request to the remote activate server 184, as depicted at 204. Responsive to the connection request 204, the remote activate server 184 sends a credentials request to the local activate server agent 118, as depicted at 208. In an example, the credentials request 208 may request the local activate server agent 118 to provide information (e.g., a digital certificate) that is used to authenticate that the local server agent 118 is affiliated with the remote activate server 184 and is affiliated with a particular branch network. As depicted at 212, the local activate server agent 118 may then respond with the credentials, and responsive to the remote activate server 184 validating the credentials, an authenticated and secure connection may then be established between the local activate server agent 118 and the remote activate server 184, as depicted at 216.

Using the secure connection 216, the remote activate server 184 may then provide user account subscription information to the local activate server agent 118, as depicted at 220. In an example, the remote activate server 184 may examine a subscription corresponding to the particular branch network containing the local activate server agent 118 for purposes of identifying network devices that are affiliated with the subscription and have yet to be onboarded, and provide (as part of the user account subscription information 220) data to the local activate server agent 118 representing these network devices. In an example, the information 220 may include information representing identifiers (e.g., MAC addresses) for the network devices.

In accordance with example implementations, the local activate server agent 118 may then open a user interface that may be used by an administrative node device 198 to locally troubleshoot issues. In this manner, a system administrator, via an administrative node 198, may communicate with the local activate server agent 118 to establish a secure connection 230 (as depicted at 224 and 228) with the user interface.

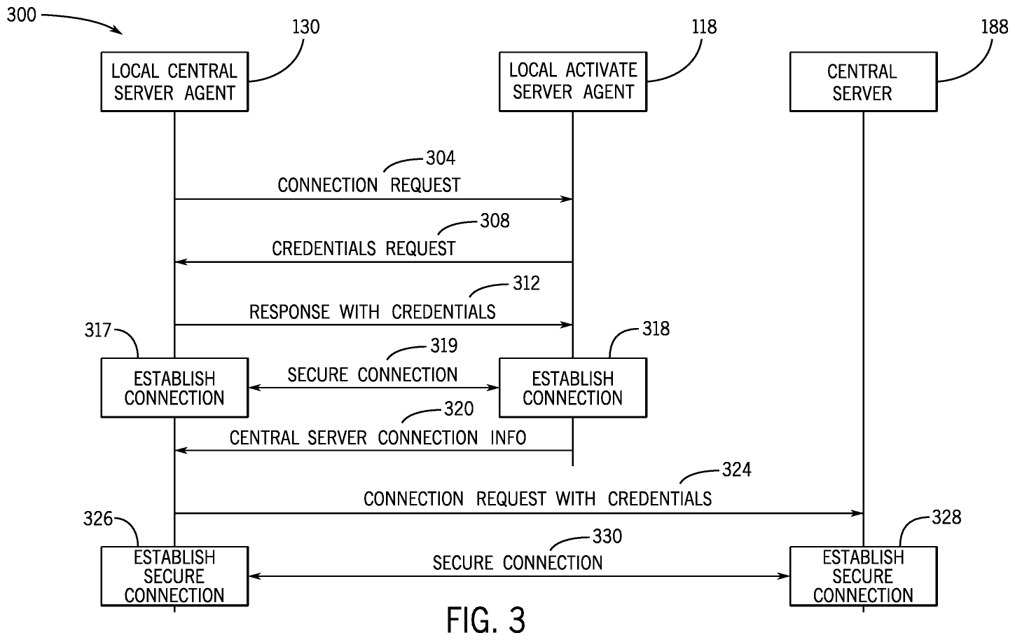

In accordance with example implementations, a local central server agent 118 may startup after the startup of the local activate server agent. FIG. 3 depicts a sequence flow diagram 300 illustrating communications associated with the startup of a local active server agent 118. In an example, a local activate server agent 118 may monitor a specific network port for discovery communications from a local central server agent 130, which represents that the local central server agent 130 is undergoing the startup process.

Referring to FIG. 3, pursuant to the sequence flow diagram 300, the local central server agent 130 first provides a connection/discovery request, as depicted at 304. The local activate server agent 118 may then observe the connection request 304 (e.g., observe the request 304 at a particular network port), and in response to the request 304, provide a credentials request, as depicted at 308. As further depicted in FIG. 3, the local central server agent 130 provides a response to the credentials request containing the credentials, as depicted at 312. The local central server agent 130 and the local activate server agent 118 may then, as depicted at 317 and 318, create a secure connection 319 between the agents 118 and 130.

The local activate server agent 118 may then, using the secure connection 319, send connection information for a central server 318, as depicted at 320. The local central server agent 130 may then provide, to the remote central server 188, a connection request with the credentials, as depicted at 324. The remote central server 188 and the local central server agent 130 may then, as depicted at 326 and 328, create a secure connection 330 between the remote central server 188 and the local central server agent 130. Through this single secure connection 330, in accordance with example implementations, the remote central server 188 and the local central server agent 130 may communicate messages between the remote central server 188 and a set of managed network devices.

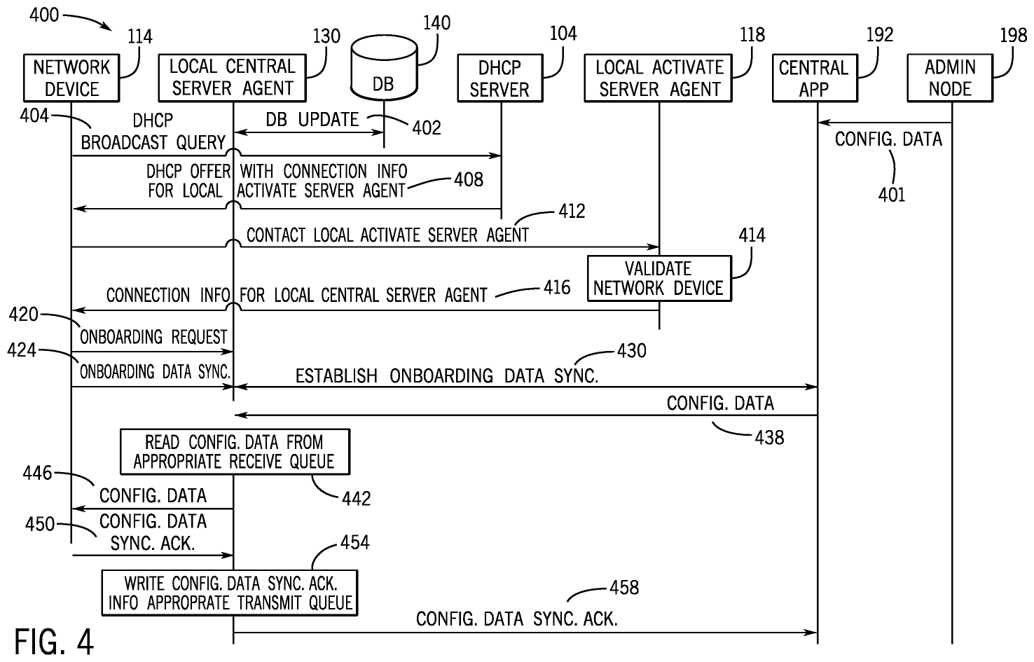

FIG. 4 depicts a sequence flow diagram 400 illustrating onboarding of a network device 114 in accordance with example implementations. In accordance with example implementations, the onboarding process may be a ZTP onboarding process. Referring to FIG. 4, the onboarding may be, as an example, preceded by an administrative node 198 uploading configuration data (e.g., a firmware image, a configuration file or other configuration information) to the central application 192, as depicted at 401. The uploading of the configuration data may occur during or after the onboarding of the network device 114, depending on the particular implementation. Moreover, in accordance with example implementations, prior to the beginning of the onboarding, the local central server agent 130 may update a local database 140 as depicted at 402, with information pertaining to the network device 114. In another example, the database update 402 may occur during the onboarding process.

The onboarding of the network device 114 occurs with the network device 114 issuing a DHCP broadcast query, which is received by a DHCP server 104, as depicted at 404. The DHCP server 104, responsive to the DHCP broadcast query, provides a DHCP offer with connection information for the local activate server agent 130, as depicted at 408. Responsive to the DHCP offer, the network device 114 may then contact the local activate server agent 412, as depicted at 412, for purposes of receiving connection information for the local central server agent, as depicted at 416.

In response to the contact from the network device 114, the local activate server 114 may validate the network device, as depicted at 414. In an example, the validation may involve the local activate server agent 118 determining whether the network device 114 is registered with the corresponding subscription. In another example, the validation may include the local activate server agent 118 determining whether the network device 114 has a valid digital certificate or possesses one or multiple other credentials. In another example, the validation by the local activate server agent 118 may include the local activate server agent 118 determining whether the network device 114 is compatible with the local branch network or corresponds to a device type associated with a minimum criteria for the local branch network. Responsive to the local activate server agent 118 successfully validating the network device 114, the local activate server agent 118 may then provide, to the network device 114, connection information for the local central server agent 130, as depicted at 416.

Responsive to receiving the connection information for the local central server agent 130, the network device 114 may then provide an onboarding request to the local central server agent 130, as depicted at 420. Moreover, as depicted at 424 and 430, the network device 114, local central server agent 130 and central application 192 may establish onboarding data synchronization. With the data synchronization established, the central application 192 may then provide configuration data to the local central agent 130. The local central server agent 130 may then read the configuration data from the appropriate received queue, as depicted at 442 and provide the configuration data to the network device 114, as depicted at 446.

In an example, the configuration data may correspond to one or multiple configuration files (e.g., yet another markup language (YAML) files). In an example, the configuration data may configure any of a number of different settings of the network device 114, such as Quality of Service (QoS) settings, Class of Service (CoS) settings, virtual local area network (VLAN) tagging settings, VLAN untagging settings, ingress bandwidth settings, egress bandwidth settings, Power over Ethernet (POE) settings, as well as different and/or other configurable settings for the network device 114. In another example, the configuration data may include a firmware image for the network device 114.

As depicted at 450, the network device 114 may provide a configuration data synchronization acknowledgement by writing the configuration data synchronization acknowledgment information to the appropriate transmit queue, as depicted at 450 and 454. Correspondingly, the local central server agent 130 may then provide a configuration data synchronization acknowledgement to the central application 192, as depicted at 458.

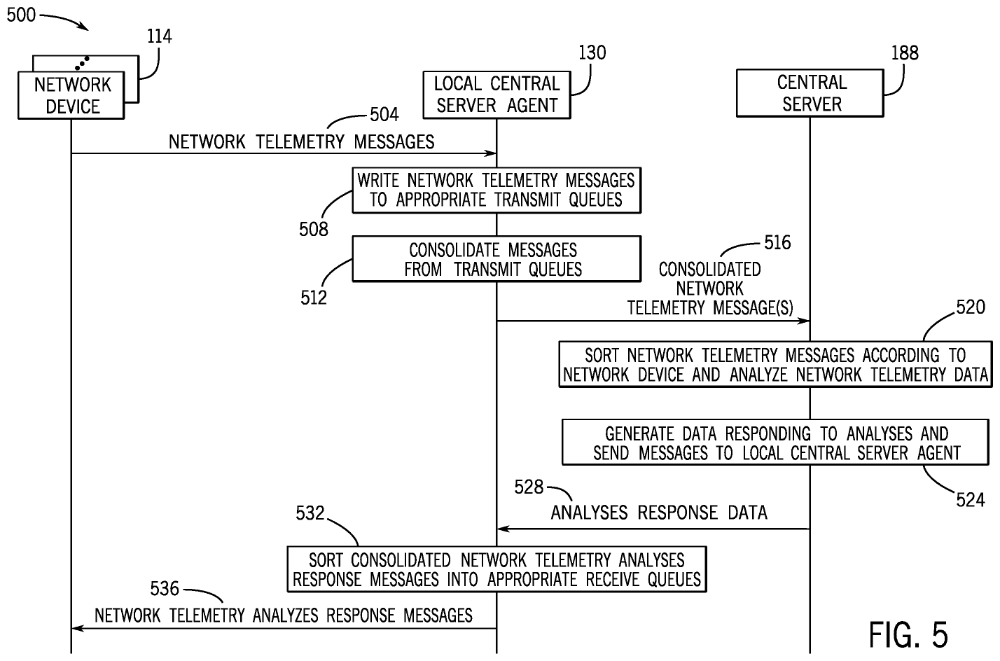

FIG. 5 depicts a sequence flow diagram 500 illustrating communications between a local central server agent 130 and a remote central server 188 for purposes of monitoring network devices and overseeing the implementation of remedial solutions to remedy issues associated with the network devices. In an example, for these purposes, the remote central server 188 may include a monitoring application and a central application, as described herein.

Referring to FIG. 5, network devices 114 may provide network telemetry messages 504, which are received by the local central server agent 130, as depicted at 504. Data corresponding to the network telemetry messages are written to corresponding transmit queues of the local central server agent 130, as depicted at 508, and the local central server agent 130 consolidates the messages from the transmit queues, as depicted at 512.

The local central server agent 130 may then send one or multiple consolidated network telemetry messages to the remote central server 188, as depicted at 516. The remote central server 188 may then sort the telemetry messages from the consolidated message(s) according to the network device, and the remote central server 188 may then analyze the network telemetry data, as depicted at 520. Moreover, for any identified issues that may be resolved by the remote central server 188, the remote central server 188 may, as depicted at 524, generate data responding to the analyses and send corresponding messages to the local central server agent, as depicted at 524 and 528.

The local central server agent 130 may then sort the consolidated telemetry analyses response messages into the appropriate receive queues as depicted at 532. From these receive queues, the local central server agent 130 may then send telemetry analysis messages to the appropriate network devices 114, as depicted at 536.

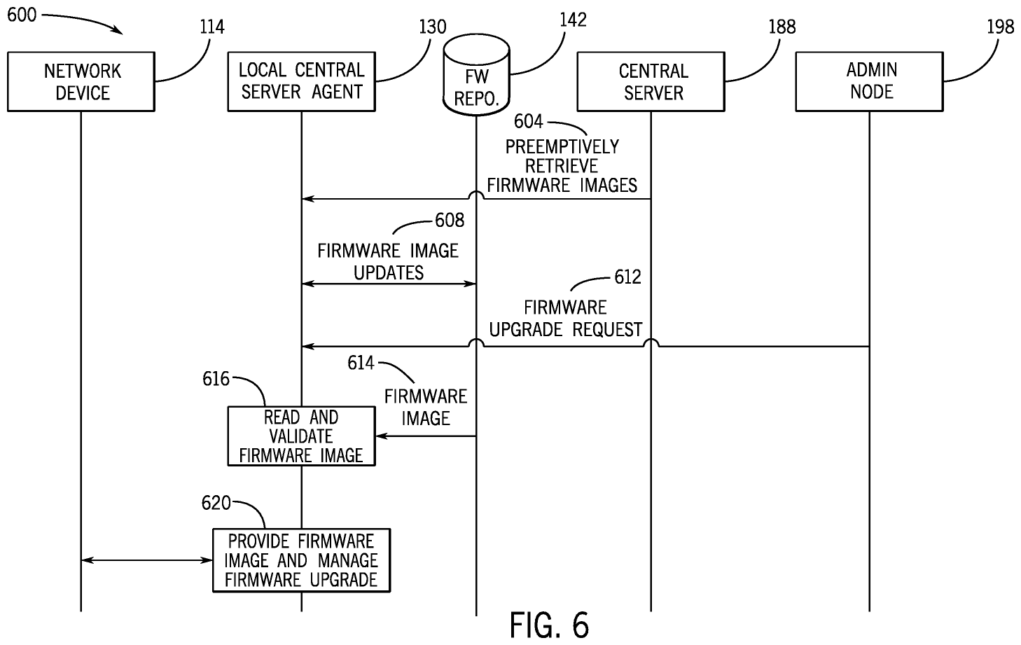

A local central server agent may preemptively retrieve newer version firmware images for its set of managed network devices, which allows the newer version firmware images to be locally available when corresponding firmware upgrades of the network devices are initiated. More specifically, FIG. 6 depicts a sequence flow diagram 600 illustrating communications related to performing a firmware upgrade on a network device 114 in accordance with example implementations.

Referring to FIG. 6, a local central server agent 130 may communicate with a remote central server 188 to preemptively retrieve firmware images from the remote central server 188, as depicted at 604. The local central server agent 130 may store the retrieved firmware images in a local firmware repository 142, as depicted at 608.

FIG. 6 depicts a firmware upgrade request 612 that is submitted from an administrative node 198 for purposes of targeting a particular network device 114 for a firmware upgrade. Moreover, for this example, the firmware upgrade corresponds to a firmware image that has been previously retrieved by the local central server agent 130 and stored in the local firmware repository 142. As an example, the firmware upgrade request 612 may be provided by an administrator selecting a firmware upgrade option and selecting the particular network device 114 from a dashboard (e.g., a dashboard provided by a central server).

In performing the firmware upgrade, the local central server agent 130 may read the appropriate firmware image from the firmware repository 142, and validate the firmware image, as depicted at 614 and 616. Responsive to the firmware image being validated, the local central server agent 130 may then communicate with the network device 114 for purposes of providing the firmware image to the network device 114 and managing the firmware upgrade, as depicted at 620.

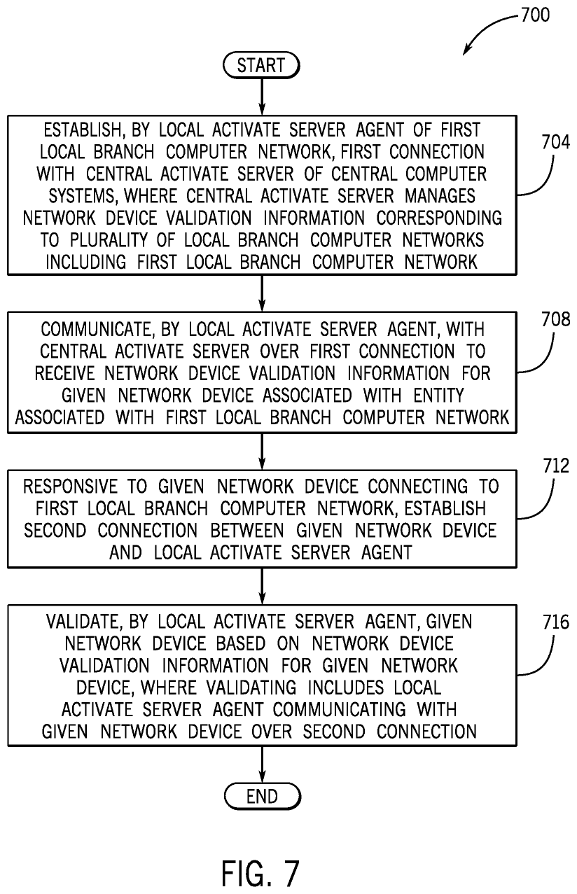

Referring to FIG. 7, in accordance with example implementations, a process 700 includes establishing (block 704), by a local activate server agent of a first local branch computer network, a first connection with an activate server of a central computer system. In an example, the central activate server may be a cloud-based server. The activate server manages network device validation information corresponding to a plurality of local branch computer networks, including the first local branch computer network. In an example, the activate server may be a cloud-based server. In examples, the local branch computer network may be an edge network, a campus network, an IoT network or a data center network.

Pursuant to block 708, the process 700 includes communicating, by a local activate server agent, with the activate server over the first connection to receive network device validation information for a given network device associated with an entity that is associated with the first local branch computer network. In an example, the given network device may be a network switch. In an example, the communication may occur prior to the first connection of the given network device with the first local branch computer network. In an example, the network device validation information may contain an identifier that corresponds to the given network device. In an example, the network device validation information may associate the identifier with a subscription. In an example, the local activate server agent may be one of an HA group of local activate server agents.

Pursuant to block 712, the process includes, responsive to the given network device connecting to the first local branch computer network, establishing a second connection between the given network device and the local activate server agent. In an example, the second connection may be established responsive to the given network device receiving connection details for the local activate server agent from a DCHP server and providing the connection details to the local activate server agent. In accordance with example implementations, the connection details may be provided as one or multiple DCHP options. In an example, the connection details may include an IP address of the local activate server agent.

Pursuant to block 716, the process 700 includes validating, by the local activate server agent, the given network device based on network device validation information for the given network device. In an example, the local activate server agent may validate the given network device responsive to the local activate server agent determining that an identifier of the given network device has been registered with a particular subscription. In an example, the local activate server agent may validate the given network device responsive to the local activate server agent determining that the network device has a device type that is compatible with the first local branch computer network. The validation includes the local activate server agent communicating with the given network device over the second connection. In an example, the local activate server agent may, responsive to validating the given network device, provide, to the given network device, connection details for a local central server agent. In an example, the local central server agent may correspond with a central server of the central computer system. In an example, the central server may be a cloud-based server. In an example, the connection details may include an IP address of the central server agent. In an example, the connection details may include a digital certificate.

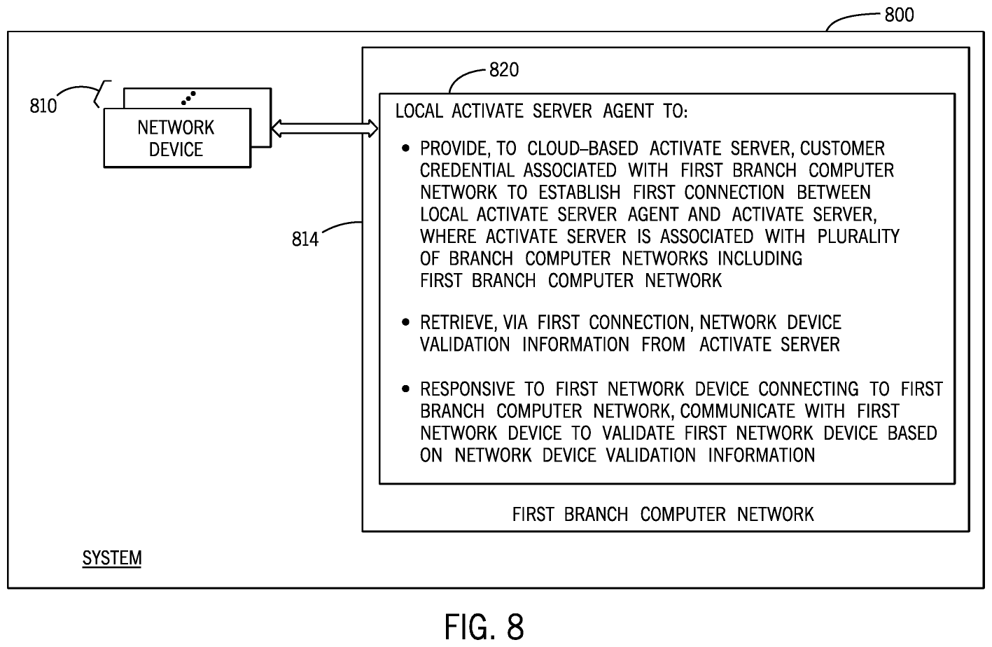

Referring to FIG. 8, in accordance with example implementations, a system 800 includes a plurality of network devices 810 and a first branch computer network 814. The first branch computer network 814 includes a local activate server agent. The local activate server agent provides, to a cloud-based activate server, a customer credential associated with the first branch computer network to establish a first connection between the local activate server agent and the activate server. The activate server is associated with a plurality of branch computer networks, which include the first branch computer network. In an example, the branch computer networks may include at least one of a campus network, a data center network, an edge network, or an IoT network. In an example, the customer credential may be an identifier that associates the first branch computer network with a subscription. In an example, the local activate server agent may be one of an HA group of multiple local activate server agents. In an example, the local activate server agent may be hosted by one or multiple nodes of the first branch computer network. In an example, the nodes may be physical nodes and/or virtual nodes. In an example, the node may be associated with one or multiple physical processors and a memory.

The local activate server agent 820 retrieves, via the first connection, network device validation information from the activate server. The local activate server agent 820, responsive to a first network device connecting to the first branch computer network, communicating with the first network device to validate the first network device based on network device validation information. In an example, the local activate server agent establishes the first connection and retrieves the network device validation information prior to the first network connection to the first branch computer network. In an example, the first network device may be a level two (L2) or level three (L3) switch. In other examples, a network device may be a gateway, a multicast router, a bridge, a component of a Gen-Z or a Compute Express Link (CXL) network, a processor device, a network interface controller (NIC) or a fabric switch that includes one or multiple of the foregoing devices.

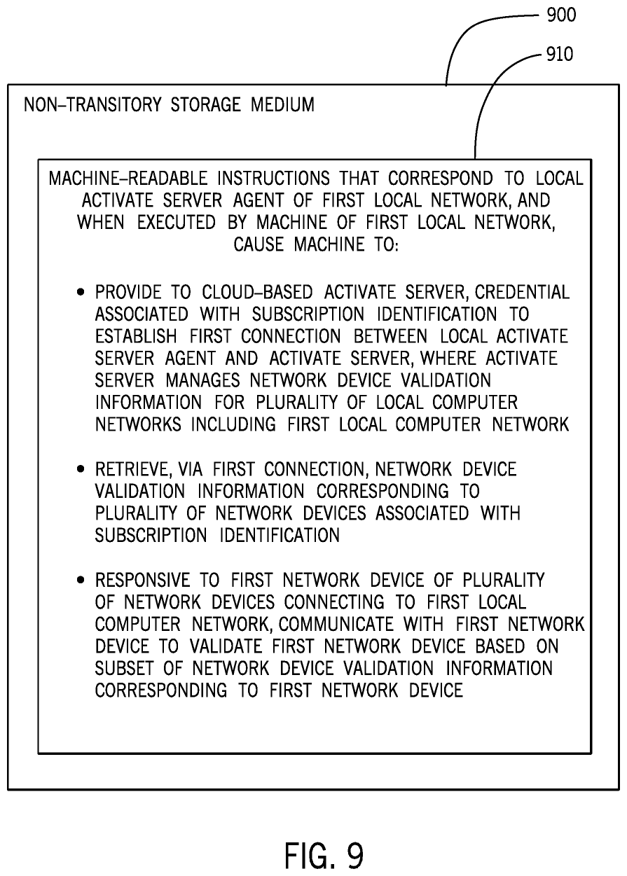

Referring to FIG. 9, in accordance with example implementations, a non-transitory storage medium 900 stores machine-readable instructions 910. The machine-readable instructions 910 correspond to a local activate server agent of a first local network. In an example, the local activate server agent may be one of an HA group of multiple local activate server agents. In an example, the local activate server agent may be hosted by one or multiple nodes of the first branch computer network. In an example, the nodes may be physical nodes and/or virtual nodes. In an example, the node may be associated with one or multiple physical processors and a memory. In an example, the first local network may be a branch network. In examples, the first local network may be a campus network, a data center network, an edge network, or an IoT network.

The machine-readable instructions 910, when executed by a machine of the first local network, cause the machine to provide to a cloud-based activate server, a credential that is associated with a subscription identification to establish a first connection between the local active server agent and a central activate server. In an example, the credential may associate the local activate server agent with a subscription account. The activate server manages network device validation information for a plurality of local computer networks including the first local branch computer network.

The machine-readable instructions 910, when executed by the machine, further cause the machine to retrieve, via a first connection, network device validation information corresponding to a plurality of network devices associated with the subscription identification. In examples, the network devices may include L2 and/or L3 switches. In other examples, the network devices may include one or multiple of the following: a gateway, a multicast router, a bridge, a component of a Gen-Z or a Compute Express Link (CXL) network, a processor device, a network interface controller (NIC) or a fabric switch that includes one or multiple of the foregoing devices.

The machine-readable instructions 910, when executed by the machine, further cause the machine, responsive to a first network device of the plurality of network devices connecting to the first local branch computer network, communicate with the first network device to validate the first network device based on a subset of the network device validation information, which corresponds to the first network device. In an example, the network device validation information may associate an identifier of the first network device with a network management service subscription. In an example, the instructions 910 may cause the machine to validate the network device based on one or multiple other criteria. In an example, a validation criterion may be a device type of the first network device. In an example, a validation criterion may be a firmware version associated with the first network device. In another example, a validation criteria may be indicative of a compatibility of the first network device with the first local branch computer network.

In accordance with example implementations, validating the given network device includes receiving, by the local activate server agent, a device identifier for the given network device and verifying, by the local activate server agent, that the device has an associated license. Among the advantages, the availability of the local activate server agent aids troubleshooting of any potential issues with the local network.

In accordance with example implementations, validating the network device includes receiving, by the local activate server agent, a device type of the given network device and verifying, by the local activate server agent, that the device type is compatible with the first local branch computer network. Among the advantages, the availability of the local activate server agent aids troubleshooting of any potential issues with the local network.

In accordance with example implementations, establishing the second connection includes sending, by a dynamic host control protocol (DHCP) server, at least one of an address of the local activate server agent or a credential for the second connection to the given network device. Among the advantages, the availability of the local activate server agent aids troubleshooting of any potential issues with the local network.

In accordance with example implementations, the local server activate agent may detect a communication from a local central server agent of the first local branch computer network. Responsive to the detection of the communication, the local server activate agent sends information to the local central server agent to allow the local central server agent to connect to a central server of the central computer system. The central server manages network devices of the plurality of local branch computer networks. The local central server agent communicates with the central server to establish a third connection between the local central server agent and the central server. Among the advantages, use of local agents, such as the local server activate agent and the local central server agent, enhances troubleshooting. Moreover, the local central server agent reduces the number of network connections with the central server.

In accordance with example implementations, the local central server agent maintains an inventory of network devices of the first local branch computer network. Responsive to successful validation of the given network device by the local activate server agent, the local central server agent adds the given network device to the inventory. Among the advantages, use of local agents, such as the local server activate agent and the local central server agent, enhances troubleshooting. Moreover, the local central server agent reduces the number of network connections with the central server.

In accordance with example implementations, the central server agent receives first messages from respective network devices of the first local branch computer network and consolidates the first messages to provide first consolidated data. The local central manager agent sends the first consolidated data to the central server via the third connection and receives second consolidated data from the central server via the third connection. The second consolidated data is separated into second messages, and the local central server agent sends the second messages to respective network devices of the first local branch computer network. Among the advantages, use of local agents, such as the local server activate agent and the local central server agent, enhances troubleshooting. Moreover, the local central server agent reduces the number of network connections with the central server.

In accordance with example implementations, the local central server agent predictably retrieves firmware images for network devices of the first local branch computer network and stores the firmware images in a repository. Firmware upgrades may then be performed for the network devices, including retrieving, by the local central server agent, the firmware images from the repository. Among the advantages, firmware upgrades of the network devices may be expedited.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
establishing, by a local activate server agent of a first local branch computer network of a plurality of local branch computer networks, a first connection with an activate server of a central computer system, wherein the activate server manages network device validation information corresponding to the plurality of local branch computer networks;
communicating, by the local activate server agent, with the activate server over the first connection to receive network device validation information for a given network device associated with an entity associated with the first local branch computer network;
responsive to the given network device connecting to the first local branch computer network, establishing a second connection between the given network device and the local activate server agent; and
validating, by the local activate server agent, the given network device based on the network device validation information for the given network device, wherein the validating comprises the local activate server agent communicating with the given network device over the second connection.

2. The method of claim 1, wherein validating the given network device comprises receiving, by the local activate server agent, a device identifier of the given network device and verifying, by the local activate server agent, that the device identifier has an associated license.

3. The method of claim 1, wherein validating the network device comprises receiving, by the local activate server agent, a device type of the given network device and verifying, by the local activate server agent, that the device type is compatible with the first local branch computer network.

4. The method of claim 1, wherein establishing the second connection comprises sending, by a dynamic host control protocol (DHCP) server, at least one of an address of the local activate server agent or a credential for the second connection to the given network device.

5. The method of claim 1, further comprising:
detecting, by the local server activate agent, a communication from a local central server agent of the first local branch computer network;
responsive to detection of the communication, sending, by the local server activate agent, information to the local central server agent to allow the local central server agent to connect to a central manager, wherein the central manger manages network devices of the plurality of local branch computer networks; and
communicating, by the local central server agent, with the central manager to establish a third connection between the local central server agent and the central manager.

6. The method of claim 5, further comprising:
maintaining, by the local central server agent, an inventory of network devices of the first local branch computer network; and
responsive to successful validation of the given network device by the local activate server agent, adding, by the local central server agent, the given network device to the inventory.

7. The method of claim 5, further comprising:
receiving, by the local central server agent, first messages from respective network devices of the first local branch computer network;
consolidating, by the local central server agent, the first messages to provide first consolidated data;
sending, by the local central server agent, the first consolidated data to the central manager via the third connection;
receiving, by the local central server agent, second consolidated data from the central manger via the third connection;
separating the second consolidated data into second messages; and
sending, by the local central server agent, the second messages to respective network devices of the first local branch computer network.

8. The method of claim 5, further comprising:
predictively retrieving, by the local central server agent, firmware images for network devices of the first local branch computer network;
storing, by the local central server agent, the firmware images in a repository; and
performing firmware upgrades of the plurality of network devices, comprising retrieving, by the local central server agent, the firmware images from the repository.

9. A system comprising:
a plurality of network devices including a first network device; and
a local activate server agent of a first branch computer network, the local activation agent to:
provide, to a cloud-based remote activate server, a customer credential associated with the first branch computer network to establish a first connection between the local activate server agent and the remote activation server, wherein the remote activation server is associated with a plurality of branch computer networks including the first branch computer network;
retrieve, via the first connection, network device validation information from the remote activate server; and
responsive to the first network device connecting to the first branch computer network, communicate with the first network device to validate the first network device based on the network device validation information.

10. The system of claim 9, further comprising:
a local central server agent of the first branch computer network, the local central server agent to:
receive connection information from the local activate server agent to allow the local central server agent to establish a second connection with a remote cloud-based central server;
receive data from the plurality of network devices; and
communicate the data received from the plurality of network devices to the remote central server via the second connection.

11. The system of claim 10, wherein:
the remote central server to process the data communicated to the remote central server by the local central server agent; and
the local central server agent to communicate, via the second connection, with the remote central server to receive data representing a result of the processing.

12. The system of claim 10, wherein the data communicated to the remote central server by the local central server agent comprises at least one of data representing statistics associated with the plurality of network devices or data representing network telemetry metrics.

13. The system of claim 10, wherein the local central server agent to communicate, via the second connection, with the remote central server to receive data representing configuration data for the plurality of network devices.

14. The system of claim 10, wherein the local central server agent to responsive to detection of a failure of the first network device, communicate data to the first network device representing a last known good configuration for the first network device.

15. The system of claim 10, wherein the local central server agent to further:
maintain an inventory of the plurality of network devices; and
responsive to the local activate server agent successfully validating the first network device, add the first network device to the plurality of network devices.

16. The system of claim 10, further comprising:
a dynamic host control protocol (DHCP) server to, responsive to the first network device connecting to the local computer network, provide, to the first network device, an address of the local activate server agent and a credential for forming a connection with the local activate server agent.

17. A non-transitory storage medium that stores machine-readable instructions that correspond to a local activate server agent of a first local network, and when executed by a machine of the first local network, cause the machine to:
provide, to a cloud-based activate server, a credential associated with a subscription identification to establish a first connection between the local activate server agent and the activate server, wherein the activate server manages network device validation information for a plurality of local computer networks including the first local branch computer network;
retrieve, via the first connection, network device validation information corresponding to a plurality of network devices associated with the subscription identification; and
responsive to a first network device of the plurality of network devices connecting to the first local branch computer network, communicate with the first network device to validate the first network device based on a subset of the network device validation information corresponding to the first network device.

18. The storage medium of claim 17, wherein the instructions, when executed by the machine, further cause the machine to retrieve the network validation information prior to any network device of the plurality of network devices initially connecting to the first local branch computer network.

19. The storage medium of claim 17, wherein the instructions, when executed by the machine, further cause the machine to:
monitor a port for a communication from a local central server agent of the first local branch computer network, wherein the local central server agent is associated with a cloud-based central server, and the central server performs network device analytics processing for the plurality of local computer networks;
responsive to detection of the communication, validate the local central server agent; and
responsive to validation of the local central server agent, provide connection information to the local central server agent to allow the local central server agent to form a connection with the central server.

20. The storage medium of claim 19, wherein the instructions, when executed by the machine, further cause the machine to, responsive to the validation of the first network device, provide connection information to the first network device to allow the first network device to form a connection with the local central server agent.
